(19) United States
(12) Patent Application Publication
(10) Pub. No.: US 2014/0055507 A1
(43) Pub. Date: Feb. 27, 2014

(54) BACKLIGHT UNIT AND VIDEO DISPLAY APPARATUS USING THE SAME

(71) Applicant: Kabushiki Kaisha Toshiba, Tokyo (JP)

(72) Inventors: Hirofumi Sakurai, Kumagaya-shi (JP); Hisayuki Mihara, Honjo-shi (JP); Yoshihiro Morito, Fukaya-shi (JP)

(73) Assignee: KABUSHIKI KAISHA TOSHIBA, Tokyo (JP)

(21) Appl. No.: 14/014,189

(22) Filed: Aug. 29, 2013

Related U.S. Application Data
(63) Continuation of application No. PCT/JP2013/057929, filed on Mar. 13, 2013.

(30) Foreign Application Priority Data
Aug. 21, 2012 (JP) JP 2012-182599

(51) Int. Cl. G09G 3/34

(52) U.S. Cl. CPC G09G 3/3406
USPC 345/690; 345/102

(57) ABSTRACT

According to one embodiment, a backlight unit is of the edge light type that guides emitted light from a light source to a liquid crystal display panel by a light guide plate for irradiation from the back surface side thereof and includes a controller. The controller is configured so that the degree of irradiation at the center of a video display screen in the liquid crystal display panel is set to be greater than that at the periphery of the screen.

### CROSS-REFERENCE TO RELATED APPLICATIONS

This application is a Continuation Application of PCT Application No. PCT/JP2013/057929, filed Mar. 13, 2013 and based upon and claiming the benefit of priority from Japanese Patent Application No. 2012-182599, filed Aug. 21, 2012, the entire contents of all of which are incorporated herein by reference.

### FIELD

Embodiments described herein relate generally to a backlight unit of the edge light type and a video display apparatus using the backlight unit.

### BACKGROUND

As is generally known, video display apparatuses using a liquid crystal display panel are currently adopted for the display of video. Such a video display apparatus reproduces video by providing a backlight on the back surface of a liquid crystal display panel that controls the amount of light transmitted for each pixel and causing the liquid crystal display panel to transmit illumination light from the backlight.

Accordingly, this type of video display apparatus can be configured to be thinner and lighter than a video display apparatus using a cathode ray tube (CRT). And particularly, the screen can easily be made larger, leading to widespread use of current large-screen digital TVs.

However, the backlight of such a video display apparatus uses a cold-cathode tube like, for example, a fluorescent tube, discharge lamp or the like as the light source and thus, there are disadvantages of higher drive power and a shorter life. Therefore, a white light emitting diode (LED) is used as the light source of backlight from the viewpoint of being able to drive at a low voltage and superior in durability.

Moreover, promoting the reduction in thickness still further can be considered in this type of video display apparatus by adopting an backlight of the edge light type, that is, a structure in which a plurality of LEDs is arranged along end faces of the liquid crystal display panel so that the back surface of the liquid crystal display panel is illuminated substantially uniformly with emitted light from each LED by a light-guiding plate.

However, a video display apparatus using a backlight of the edge light type is still in the stage of development and there is much room for improvement in various respects before commercialization. Particularly, it is important to save power by reducing the number of LEDs constituting a backlight or drive power.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a side view schematically illustrating an example of a liquid crystal display apparatus as an embodiment;

FIG. 2 is a front view illustrating an example of a backlight unit constituting the liquid crystal display apparatus in the embodiment;

FIG. 3 is a plan view illustrating an example of an LED bar constituting the backlight unit in the embodiment;

FIG. 4 is a front view illustrating a modification of the backlight unit in the embodiment;

FIG. 5 is a diagram illustrating the modification of the backlight unit in the embodiment in detail;

FIG. 6 is a front view illustrating another modification of the backlight unit in the embodiment;

FIG. 7 is a front view illustrating still another modification of the backlight unit in the embodiment;

FIG. 8 is a plan view illustrating an example of a connection relationship between a printed circuit board and an LED of the LED bar in the embodiment;

FIG. 9 is a circuit configuration diagram illustrating an equivalent circuit regarding the connection of the LED of the LED bar in the embodiment;

FIG. 10 is a circuit configuration diagram illustrating an example of a drive circuit to energize and drive the LED of the LED bar in the embodiment;

FIG. 11 is a plan view illustrating another example of the LED bar constituting the backlight unit in the embodiment; and

FIG. 12 is a plan view illustrating still another example of the LED bar constituting the backlight unit in the embodiment.

### DETAILED DESCRIPTION

Various embodiments will be described hereinafter with reference to the accompanying drawings.

In general, according to one embodiment, a backlight unit is of the edge light type that guides emitted light from a light source to a liquid crystal display panel by a light guide plate for irradiation from the back surface side thereof and includes a controller. The controller is configured so that the degree of irradiation at the center of a video display screen in the liquid crystal display panel is set to be greater than that at the periphery of the screen.

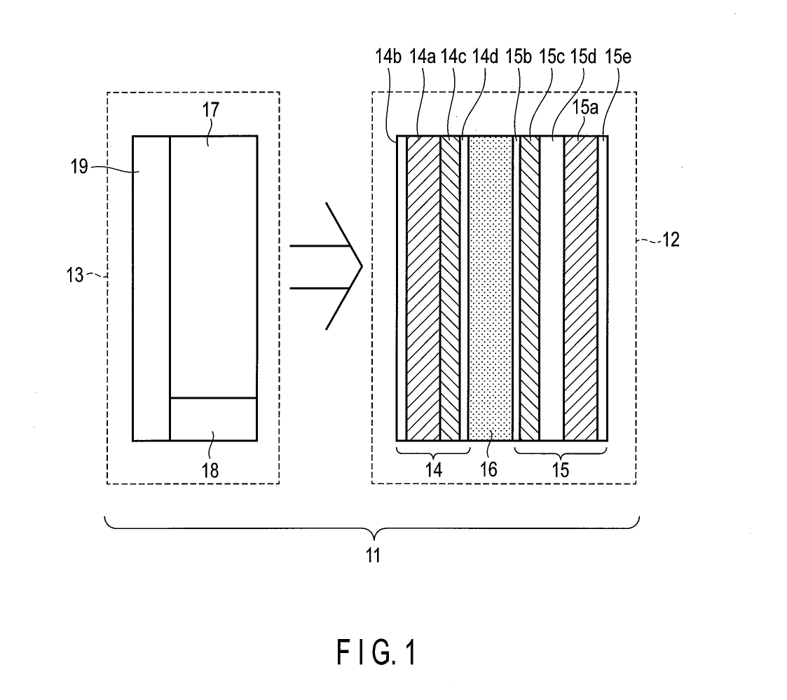

FIG. 1 schematically shows an example of a liquid crystal display apparatus 11 as a video display apparatus described in the embodiment. The liquid crystal display apparatus 11 includes a liquid crystal display panel 12 that controls the amount of light transmitted for each pixel and a backlight unit 13 that irradiates the back surface of the liquid crystal display panel 12 with illumination light.

The liquid crystal display panel 12 of these units forms a liquid crystal layer 16 by sealing a liquid crystal between a substrate module 14 on a pixel driving side and a substrate module 15 on a counter electrode side while the substrate modules 14, 15 are opposed to each other and separated by a predetermined distance.

The substrate module 14 on the pixel driving side has a polarizing plate 14b stacked on one side of a glass substrate 14a and a transparent conductive film 14c on which a pixel electrode and a driving thin transistor are formed and an orientation film 14d stacked on the other side of the glass substrate 14a.

Further, the substrate module 15 on the counter electrode side has an orientation film 15b, a transparent conductive film 15c on which a counter electrode is formed, and a color filter 15d stacked on one side of a glass substrate 15a and a polarizing plate 15e stacked on the other side of the glass substrate 15a.

The backlight unit 13 has a structure of the edge light type and includes a light guide plate 17 installed to surface-oppose the back surface of the liquid crystal display panel 12. A light source unit 18 is installed at one end (lower end in FIG. 1) of the light guide plate 17 and also a reflector 19 is installed on a surface on the opposite side of the surface opposed to the liquid crystal display panel 12.

The backlight unit 13 irradiates the lower end of the light guide plate 17 with emitted light from the light source unit 18. Accordingly, the emitted light from the light source unit 18 is taken in by the light guide plate 17 and emitted from the surface on the opposite side of the installation surface of the reflector 19. Thus, the entire region of the back surface of the liquid crystal display panel 12 can be irradiated with light from the backlight unit 13.

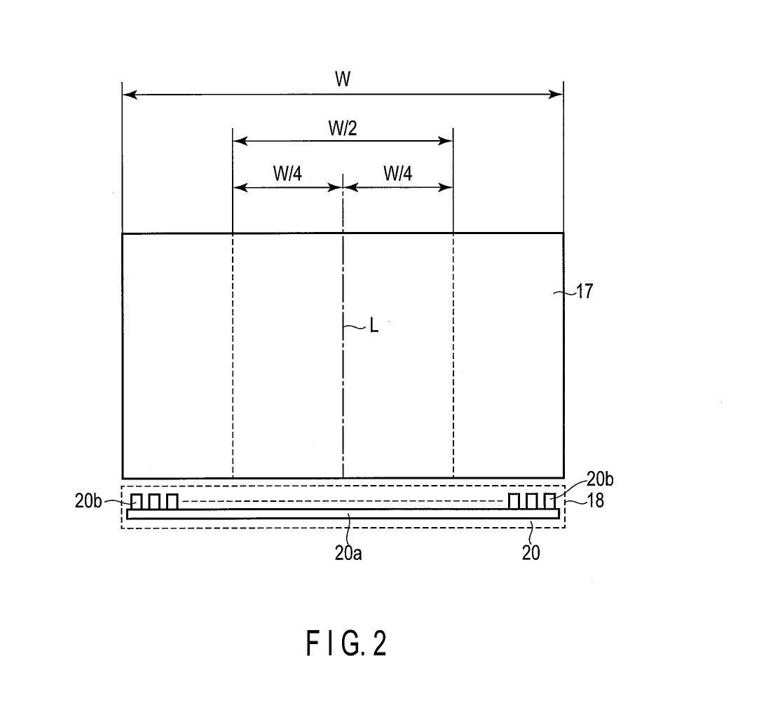

FIG. 2 shows an example of the state of the light guide plate 17 and the light source unit 18 when viewed from the emission side of light, that is, from the side of the liquid crystal display panel 12. That is, the light guide plate 17 includes a light emission surface of substantially the same size as the liquid crystal display panel 12, that is, substantially the same size as the video display screen of the liquid crystal display apparatus 11.

The light source unit 18 includes an LED bar 20 disposed along the lower end of the light guide plate 17. The LED bar 20 includes a linear printed circuit board 20a disposed along the lower end of the light guide plate 17 and a plurality of LEDs 20b, 20b, . . . on the printed circuit board 20a connected at equal intervals along the longitudinal direction thereof. It is assumed that, for example, white LEDs are adopted as the LEDs 20b, 20b, . . . .

Then, emitted light from each of the LEDs 20b, 20b, . . . enters the lower end of the light guide plate 17 after the LEDs 20b, 20b, . . . being energized and driven. Accordingly, the light entering the light guide plate 17 is shone from the light emission surface toward the back surface of the liquid crystal display panel 12.

In the liquid crystal display apparatus 11, the feeling of brightness of display video when the viewer looks at the screen is improved by increasing luminance (brightness) in the center of the video display screen.

That is, if the luminance at the center of the video display screen is increased, the viewer can be made to feel that the display video is bright without increasing the luminance of the whole screen, that is, without increasing the luminance of the periphery of the screen. Accordingly, power can be saved by decreasing the number of LEDs 20b, 20, . . . as light sources or reducing drive power.

How much luminance should be higher in the center of the video display screen than the luminance at the periphery of the screen, that is, a difference between luminance at the center of the video display screen and luminance at the periphery of the screen is naturally set within a range in which the viewer is not made to find the brightness of the screen is unnatural.

Thus, to set the luminance at the center of the video display screen higher than that at the periphery of the screen, the amount of light emitted by, of the LEDs 20b, 20b, . . . constituting the LED bar 20, the LEDs 20b, 20b, . . . emitting light shining on the center of the video display screen is made greater than that of the LEDs 20b, 20b, . . . emitting light shining on the periphery of the screen.

In this case, the center of the video display screen where the luminance should be increased is assumed to be a range of, if the length of the light guide plate 17 in the horizontal direction is w, the total length of w/2 or less with the respective length of up to w/4 in the left and right direction from a center line L dividing the light guide plate 17 into two in the horizontal direction. Further, the periphery of the screen is assumed to be a range outside the above range.

In addition, the luminance in the vertical direction is set substantially uniformly in each region inside the above range (center of the video display screen) and outside the above range (periphery of the screen). That is, the center of the video display screen and the periphery of the screen are defined as the respective range in the horizontal direction of the screen and are not defined as the range in the vertical direction.

Thus, the viewer can be made to feel that the display video is bright without increasing the luminance of the whole screen by setting the luminance at the center of the video display screen in the horizontal direction higher than that at other portions.

That is, if the center of the video display screen is set as a range of the length of up to w/2 in the horizontal direction in the center of the light guide plate 17 and the luminance in the range is set to be higher than the luminance at the periphery of the screen, an effect of making the viewer feel that the display video is bright can be obtained.

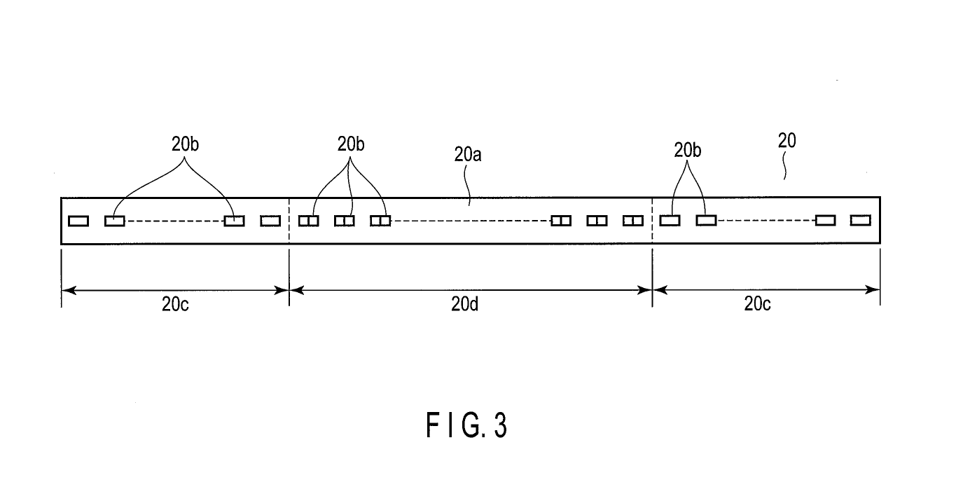

FIG. 3 shows an example of a unit for making the amount of light emitted by, of the LEDs 20b, 20b, . . . constituting the LED bar 20, the LEDs 20b, 20b, . . . emitting light shining on the center of the video display screen greater than that of the LEDs 20b, 20b, . . . emitting light shining on the periphery of the screen.

That is, the LEDs 20b, 20b, . . . emitting light shining on the periphery of the screen, that is, the LEDs 20b, 20b, . . . installed in regions 20c, 20c at both ends of the LED bar 20 shown in FIG. 3 are integrated into a normal 1-chip LED in which one LED chip is housed in one LED cabinet.

Further, the LEDs 20b, 20b, . . . emitting light shining on the center of the video display screen, that is, the LEDs 20b, 20b, . . . installed in a region 20d in the center of the LED bar 20 shown in FIG. 3 are integrated into a 2-chip LED in which two LED chips are housed in one LED cabinet. In this manner, the degree of irradiation at the center of the video display screen is made greater than that at the periphery of the screen.

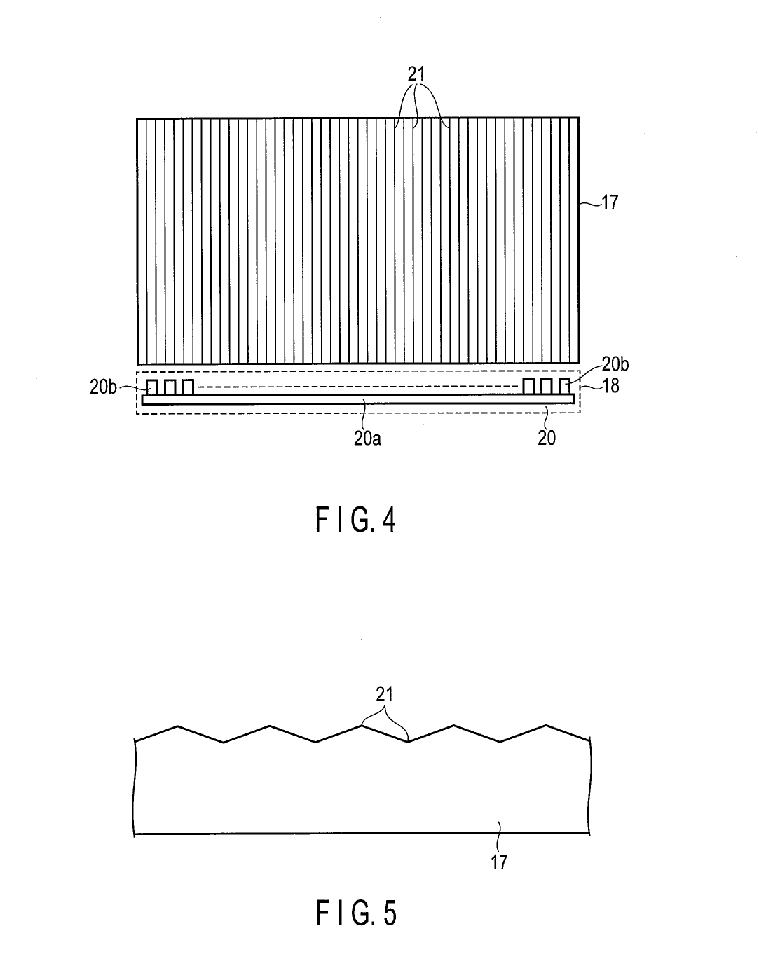

FIG. 4 shows a modification of the light guide plate 17. That is, a lens portion 21 in a mountainous or grooved shape as exemplified in FIG. 5 is formed on the light emission surface of the light guide plate 17 in the longitudinal direction of the LED bar 20 constituting the light source unit 18, that is, a direction perpendicular to the arrangement direction of the LEDs 20b, 20b, . . . .

By forming the lens portion 21 on the light emission surface of the light guide plate 17 along the vertical direction of the video display screen as described above, the light emitted from the light source unit 18 and entering the lower end of the light guide plate 17 is substantially uniformly guided through the light guide plate 17 in the vertical direction without being diffused wastefully and emitted from the light emission surface thereof to the back surface of the liquid crystal display panel 12.

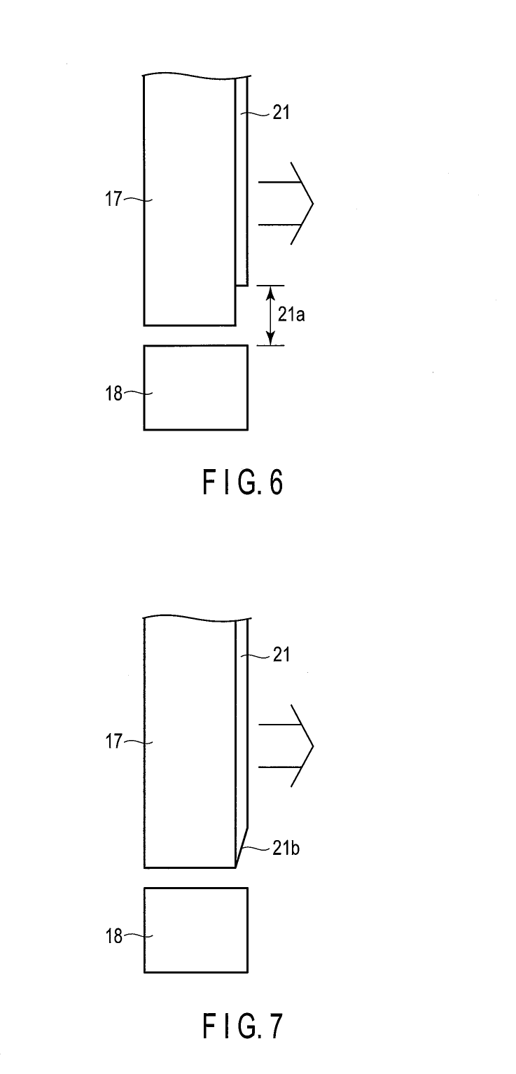

Further, emitted light from the light source unit 18 can gradually be broadened into the light guide plate 17 by, as shown in FIG. 6, forming the lens portion 21 of the light guide plate 17 spaced from the light source unit 18 (that is, the LED 20b) by a predetermined interval 21a or, as shown in FIG. 7, forming a taper portion 21b having a slight inclination near the light source unit 18 (that is, the LED 20b) of the lens portion 21 of the light guide plate 17.

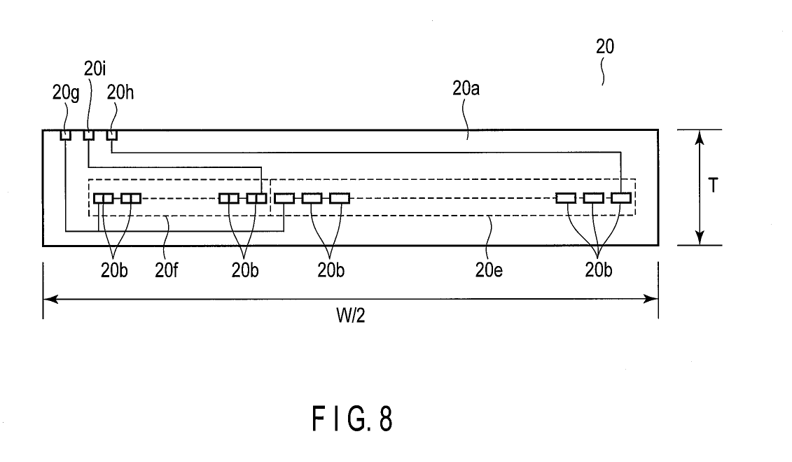

Next, FIG. 8 shows an example of a connection relationship between the printed circuit board 20a and the LEDs 20b, 20b, . . . constituting the LED bar 20. Normally, instead of forming the LED bar 20 having length w in the horizontal direction of the light guide plate 17, LED bars having length w/2, which is half the length of the light guide plate 17 in the horizontal direction, are formed and two such LED bars are aligned in the longitudinal direction thereof to correspond to length w of the light guide plate 17 in the horizontal direction. Thus, in FIG. 8, the LED bar 20 having half length w/2 of the light guide plate 17 in the horizontal direction, that is, one of the LED bars 20 obtained by dividing the LED bar 20 shown in FIG. 3 into two portions in the center thereof is shown.

Then, the LEDs 20b, 20b, . . . using 1-chip LEDs, that is, the LEDs 20b, 20b, . . . in an LED group 20e enclosed by a dotted line are connected in series in the forward direction on the printed circuit board 20a.

Further, the LEDs 20b, 20b, . . . using 2-chip LEDs, that is, the LEDs 20b, 20b, . . . in an LED group 20f enclosed by a dotted line are connected in series in the forward direction on the printed circuit board 20a.

In this case, the number of LEDs 20b, 20b, . . . in LED group 20e and the number of LEDs 20b, 20b, . . . in LED group 20f are set so that the sum of forward voltages of the LEDs 20b, 20b, . . . in LED group 20e and the sum of forward voltages of the LEDs 20b, 20b, . . . in LED group 20f are substantially equal.

In other words, the numbers thereof are set so that the total number of LED chips held by the LEDs 20b, 20b, . . . in LED group 20e and the total number of LED chips held by the LEDs 20b, 20b, . . . in LED group 20f are the same. More specifically, if the number of LEDs 20b, 20b, . . . (each of which has one LED chip) in LED group 20e is n, the number of LEDs 20b, 20b, . . . in LED group 20f is set to n/2.

By making the total number of LED chips held by the LEDs 20b, 20b, . . . in LED group 20e and the total number of LED chips held by the LEDs 20b, 20b, . . . in LED group 20f equal as described above, the anode of the LED chip positioned furthest upstream inside LED group 20e and the anode of the LED chip positioned furthest upstream inside LED group 20f can be connected to a common positive power terminal 20g. Accordingly, traces on the printed circuit board 20a can be simplified and a width T of the printed circuit board 20a can be made shorter.

Incidentally, the cathode of the LED chip positioned furthest downstream inside LED group 20e is connected to a negative power terminal 20h and the cathode of the LED chip positioned furthest downstream inside LED group 20f is connected to a negative power terminal 20i.

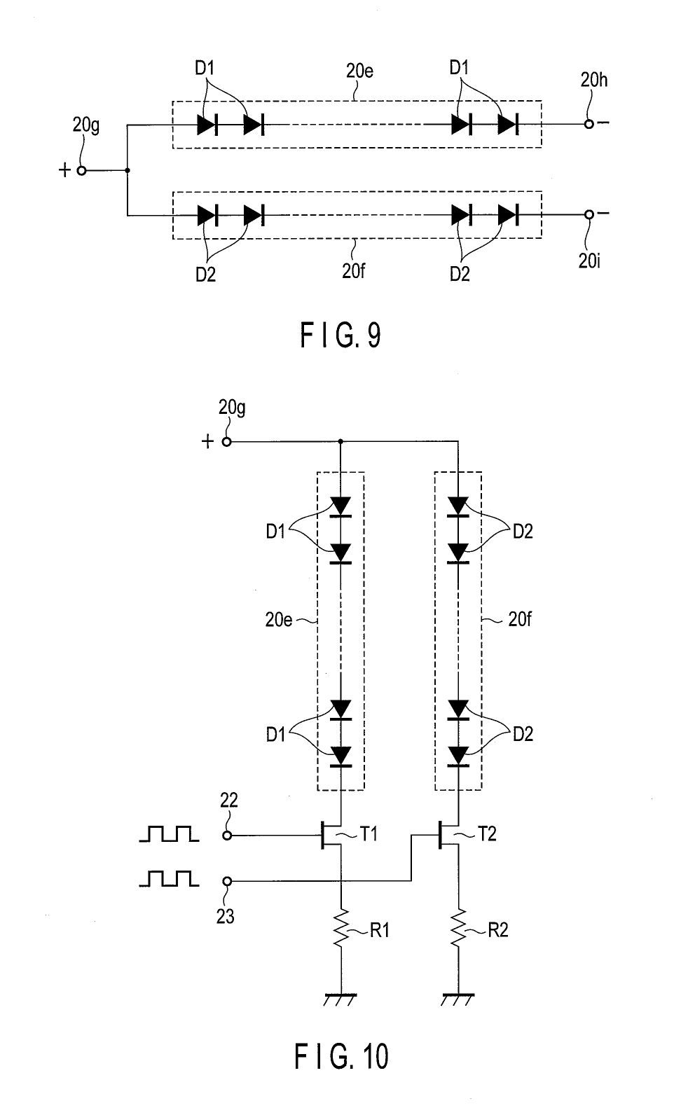

FIG. 9 shows a connected state of each of the LEDs 20b, 20b, . . . shown in FIG. 8 as an equivalent circuit. That is, LED chips D1, D1, . . . held by the LEDs 20b, 20b, . . . in LED group 20e are connected in series. Further, LED chips D2, D2, . . . held by the LEDs 20b, 20b, . . . in LED group 20f are connected in series. The number of LED chips D1, D1, . . . and the number of LED chips D2, D2, . . . are the same.

The anode of LED chip D1 positioned furthest upstream of LED chips D1, D1, . . . and the anode of LED chip D2 positioned furthest upstream of LED chips D2, D2, . . . are commonly connected to the positive power terminal 20g.

Further, the cathode of LED chip D1 positioned furthest downstream of LED chips D1, D1, . . . is connected to the negative power terminal 20h and the cathode of LED chip D2 positioned furthest downstream of LED chips D2, D2, . . . is connected to the negative power terminal 20i.

FIG. 10 shows an example of a drive circuit to energize and drive LED chips D1, D1, . . . and LED chips D2, D2, . . . connected as described above. That is, the cathode of LED chip D1 positioned furthest downstream of LED chips D1, D1, . . . is grounded via a switching element T1 and a resistor R1. Then, the amount of light emitted by LED chips D1, D1, . . . is controlled by switching control of switching element T1 by a pulse width modulation signal supplied to an input terminal 22 to control the current passed to LED chips D1, D1, . . . .

Further, the cathode of LED chip D2 positioned furthest downstream of LED chips D2, D2, . . . is grounded via a switching element T2 and a resistor R2. Then, the amount of light emitted by LED chips D2, D2, . . . is controlled by switching control of switching element T2 by a pulse width modulation signal supplied to an input terminal 23 to control the current passed to LED chips D2, D2, . . . .

According to the above drive circuit, the amount of light emitted by LED chips D1, D1, . . . , that is, the luminance at the periphery of the video display screen and the amount of light emitted by LED chips D2, D2, . . . , that is, the luminance at the center of the video display screen can independently be controlled by changing a duty ratio of pulse width modulation signals supplied to the input terminals 22, 23.

Therefore, by making the luminance of the center of the video display screen and the luminance at the periphery of the video display screen controllable independently, for example, when the liquid crystal display apparatus 11 is used to demonstrate a video display in a store, the attention of customers can be attracted by providing a video display of a bright screen in which the luminance at the center and at the periphery of the screen is increased.

Further, when the liquid crystal display apparatus 11 is used to produce a video display at home, power consumption can be reduced while a feeling of brightness is given to the viewer by setting the luminance at the center of the screen to a normal level and lowering the luminance of the periphery of the screen below the normal level.

Further, when a situation in which the viewer feels uncomfortable with the brightness of video display because of special reproduction such as scrolling and fast reproduction arises during video display, the circumstance can be adequately handled by controlling the luminance at the center of the screen and that of the periphery independently.

If, for example, the number of LEDs 20b, 20b, . . . in LED group 20e increases and the drive voltage level cannot be secured when all the LEDs 20b, 20b, . . . are connected in series, the LEDs 20b, 20b, . . . in LED group 20e are divided into groups of a predetermined number of LEDs 20b, 20b, . . . and each of the divided groups of the LEDs 20b, 20b, . . . is connected in series to constitute a plurality of unit LED groups and the drive voltage is applied to each unit LED group.

In this case, if the sum of forward voltages of all the LEDs 20b, 20b, . . . constituting LED groups 20e, 20f is set substantially as an integral multiple the sum of forward voltages of the LEDs 20b, 20b, . . . constituting one unit LED group, the anode of the LED positioned furthest upstream of each unit LED group can commonly be connected to a positive power terminal and thus, as described with reference to FIG. 8, traces on the printed circuit board 20a can be simplified.

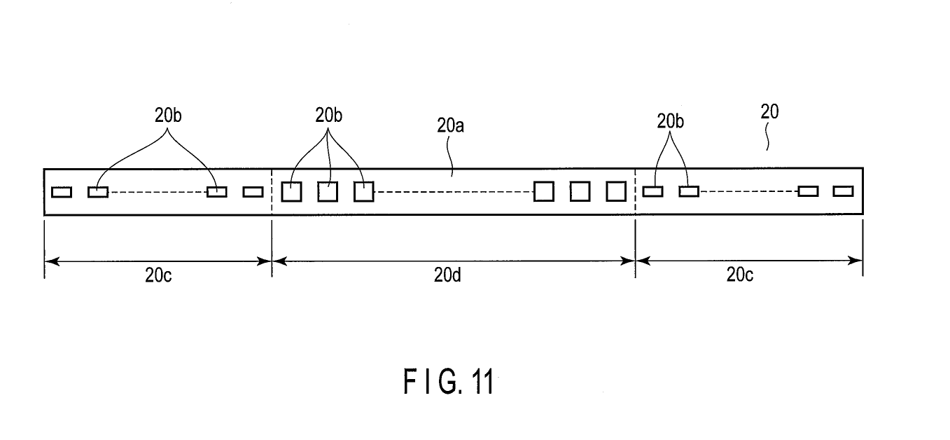

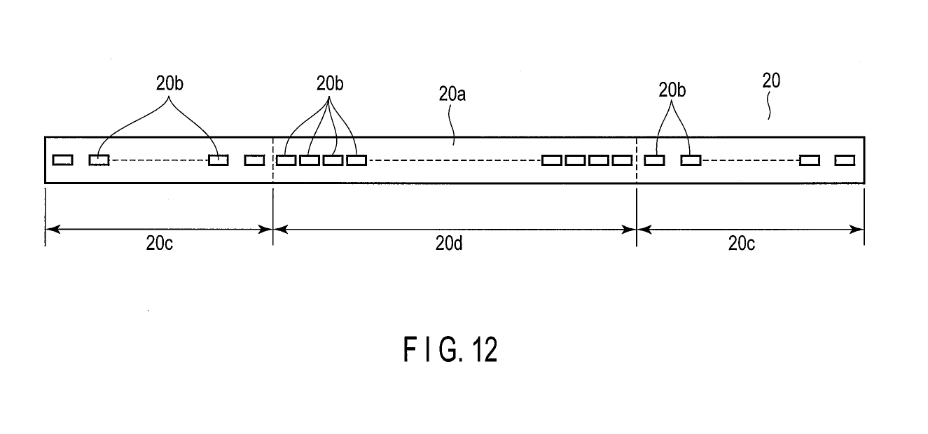

Each of FIGS. 11 and 12 shows another example of the unit for making the amount of light emitted by, of the LEDs 20b, 20b, . . . constituting the LED bar 20, the LEDs 20b, 20b, . . . emitting light shining on the center of the video display screen greater than that of the LEDs 20b, 20b, . . . emitting light shining on the periphery of the screen.

That is, in the example shown in FIG. 11, by setting the chip area of the LEDs 20b, 20b, . . . installed in the region 20d in the center of the LED bar 20 twice that of the LEDs 20b, 20b, . . . installed in the regions 20c, 20c at both ends of the LED bar 20, the degree of irradiation at the center of the video display screen is made greater than that at the periphery of the screen.

In the example shown in FIG. 12, by setting the density of the LEDs 20b, 20b, . . . installed in the region 20d in the center of the LED bar 20 twice that of the LEDs 20b, 20b, . . . installed in the regions 20c, 20c at both ends of the LED bar 20, the degree of irradiation at the center of the video display screen is made greater than that at the periphery of the screen.

Further, by making the current passed to the LEDs 20b, 20b, . . . installed in the region 20d in the center of the LED bar 20 greater than that passed to the LEDs 20b, 20b, . . . installed in the regions 20c, 20c at both ends of the LED bar 20, the degree of irradiation at the center of the video display screen can also be made greater than that at the periphery of the screen.

Also by appropriately combining the technique described with reference to FIGS. 3, 11, and 12 and the technique to vary the current passed to the LEDs 20b, 20b, . . . , the degree of irradiation at the center of the video display screen can be made greater than that at the periphery of the screen.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A backlight unit of an edge light type configured to guide emitted light from a light source to a liquid crystal display panel by a light guide plate for irradiation from a back surface side thereof comprising:
a controller configured to set a degree of irradiation at a center of a video display screen in the liquid crystal display panel to be greater than that at a periphery of the screen.

2. The backlight unit of claim 1, wherein the controller is configured to set an amount of light, emitted from the light source, where in the light source is configured to irradiate the center of the video display screen in the liquid crystal display panel greater than the periphery of the screen.

3. The backlight unit of claim 2, wherein the light source has a plurality of LEDs arranged along one end of the light guide plate and
the controller is configured to set the degree of irradiation at the center of the video display screen in the liquid crystal display panel to be greater than that at the periphery of the screen by using at least one of a configuration in which, the LEDs irradiating the center of the video display screen in the liquid crystal display panel with light are 2-chip LEDs and the LEDs irradiating the periphery of the screen with the light are 1-chip LEDs,
a configuration in which, a chip area of the LEDs irradiating the center of the video display screen in the liquid crystal display panel with the light is configured to be greater than that of the LEDs irradiating the periphery of the screen with the light,
a configuration in which, a density of the LEDs arranged in a region capable of irradiating the center of the video display screen in the liquid crystal display panel with the light is configured to be greater than that of the LEDs arranged in another region capable of irradiating the periphery of the screen with the light, and
a configuration in which a drive current flows to the LEDs irradiating the center of the video display screen in the liquid crystal display panel with the light is configured to be greater than that flows to the LEDs irradiating the periphery of the screen with the light.

4. The backlight unit of claim 1, wherein the controller is configured to set the degree of irradiation at the center in a horizontal direction of the video display screen in the liquid crystal display panel greater than that at the periphery in the horizontal direction of the screen and to set the amount of irradiation in a vertical direction of the video display screen substantially uniformly.

5. The backlight unit of claim 1, wherein the light source has a plurality of LEDs arranged along one end of the light guide plate and
the light guide plate has a lens portion in a mountainous or grooved shape formed to prevent diffusion of light incident from the LEDs in a direction perpendicular to an arrangement direction of the LEDs.

6. The backlight unit of claim 5, wherein the lens portion is formed on the light guide plate by being spaced apart from the LEDs by a predetermined interval.

7. The backlight unit of claim 5, wherein the lens portion has a tapered shape formed near the LEDs.

8. The backlight unit of claim 1, wherein the light source has a plurality of LEDs arranged along one end of the light guide plate, comprising:
a first light emission amount controller configured to control an amount of light emission of first LEDs that irradiate the center of the video display screen in the liquid crystal display panel with light by controlling an energizing current to the first LEDs through a first pulse width modulation signal; and
a second light emission amount controller configured to control the amount of light emission of second LEDs that irradiate the periphery of the video display screen in the liquid crystal display panel with the light by controlling the energizing current to the second LEDs through a second pulse width modulation signal.

9. The backlight unit of claim 8, wherein
a sum of forward voltages of the LEDs constituting the light source is set as a substantially integral multiple of the sum of forward voltages of LEDs constituting one unit LED group, wherein a plurality of unit LED groups is obtained by dividing the second LEDs into groups having a predetermined number of LED.

10. A video display apparatus comprising a backlight unit of an edge light type configured to guide emitted light from a light source to a liquid crystal display panel by a light guide plate for irradiation from a back surface side thereof, wherein
the backlight unit comprises a controller configured to set a degree of irradiation at a center of a video display screen in the liquid crystal display panel to be greater than that at a periphery of the screen.
